(19) United States
(12) Patent Application Publication
(10) Pub. No.: US 2002/0166862 A1
(43) Pub. Date: Nov. 14, 2002

(54) Modular pressure vessel unheading and containment system

(76) Inventors: Allen S. Malsbury, Parsippany, NJ (US); Ronald T. Myszka, Bethlehem, PA (US); Mark Hassert, Summit, NJ (US)

Correspondence Address: FITZPATRICK CELLA HARPER & SCINTO, 30 ROCKEFELLER PLAZA, NEW YORK, NY, 10112, US

(21) Appl. No.: 09/852,622

(22) Filed: May 11, 2001

(51) Int. Cl. F17C 1/00

(52) U.S. Cl. 220/581

(57) ABSTRACT

An unheading and containment system for unheading and heading a pressure vessel includes an unheading apparatus for removing a cover from a pressure vessel in an unheading operation and a modular enclosure mechanism to substantially enclose the cover during the unheading operation. The unheading apparatus includes a cover removably secured to the pressure vessel, a lock plate cooperating with the cover, and a cover moving mechanism capable of moving the cover vertically and laterally.

### FIELD OF THE INVENTION

This invention relates to pressure vessels, and more particularly to a modular containment system for unheading and heading a cover from the pressure vessel. This invention is particularly applicable to removing bottom covers from coke drums.

### BACKGROUND OF THE INVENTION

The processing of crude oil into gasoline, diesel fuel, lubricants and the like, as well as many other petroleum refining operations, produce byproducts that have very little value. However, the value of these byproducts can be substantially increased when they are heated long enough and to a temperature high enough to cause what is known as “destructive distillation.” During the process of destructive distillation, a portion of the byproducts are converted to usable hydrocarbon products. The remainder is transformed into a solid carbon product called “coke.” The temperature necessary to incur destructive distillation is typically about 900° F. Thus, the heat of an industrial furnace is required to incur destructive distillation.

A large pressure vessel known as a coke drum is provided at a furnace outlet to allow sufficient residence time for a complete destructive distillation reaction. A typical coke drum is a large metal vessel, usually disposed vertically with top and bottom closure arrangements, although the actual structural size and shape of the coke drum can vary considerably from one installation to another. The bottom closure typically includes a removable cover that is relatively large and heavy and is secured to the drum by dozens of bolts. The disengagement and reengagement of the removable cover, known as unheading and heading, respectively, can be quite labor intensive, given the mass of the cover and the numerous bolts that hold it in place.

During the refining process petroleum byproducts are deposited in the coke drum as a hot liquid slurry. Typically, the slurry enters the drum through an opening in the bottom closure. Lighter hydrocarbons, the products of destructive distillation, flow out the top of the coke drum while heavier material remains in the drum.

After a coke drum is filled to the desired capacity and the flow of slurry into the drum ceases, the drum is cooled. A typical cooling procedure includes injecting steam into the drum to strip useful hydrocarbon vapors from the solid material and then injecting water to further cool the coke. The liquid mass remaining in the coke drum is substantially full of coke that, as it cools, hardens into solid material. This solid coke forms as the drum cools and must be removed from the drum so that the drum can be reused. Removal of coke from a drum is referred to as “decoking.”

A typical decoking process involves several steps. First, the water is drained from the drum through piping to allow for removal of the cover from the bottom closure of the drum. In a hydraulic operation, as opposed to a manual operation, the cover is supported by a hydraulic lifting mechanism to detension the joint. Next, the cover must be unlocked from the coke drum and then disengaged in a controlled manner by manipulating the bolts attaching it to a flange on the drum. The cover is then lowered by the hydraulic mechanism. The operation is reversed to resecure the cover in place. As can be appreciated, unheading a coke drum can be a time consuming process. After unheading is complete, the coke in the drum is cut out of the drum by high pressure water jets.

To help streamline the unheading process, oil refineries are using automated unheading procedures. Unheading devices provided at the lower end of the coking drums for automatic and semi-automatic heading and unheading and which are capable of remote operation are known. For example, a remotely operated unheading device for coking drums is disclosed by U.S. Pat. No. 4,726,109 to Malsbury et al. In this patent, a platform device supports a head unit, or cover, removed from the coke drum. Pistons are provided for moving the platform device both vertically and laterally. The platform device can also be tipped to provide an easier angle for cleaning out the head unit.

Other examples of remotely removable closures are shown in U.S. Pat. Nos. 4,820,384, 5,290,072 and 5,221,019. For example, in the '384 patent, to Pechacek, a remotely operable vessel cover assembly includes a cover which can be attached to a flange surrounding an opening in the vessel. When the cover is raised into position, a series of connector pins fits through corresponding holes in a force ring and keyhole-shaped holes in a lock ring, which lock ring is rotated so that heads of the connector pins are locked behind the lock ring. Fluid pressure is then applied to a force actuator, pressurizing inner and outer annular rings, which expand to pre-stress the pins and the cover. A ramp ring is then rotated until a series of ramps firmly contact a complementary series of ramps on the cover. The force actuator is then depressurized. According to this patent, the angle of inclination of the ramps is sufficiently shallow that friction between the ramp ring and the cover prevents slippage.

Automatic and semi-automatic unheading devices that confine the flow of discharge from the drum to a storage arrangement by means of a chute are also known in the art. For example, U.S. Pat. No. 6,039,844 to Malik discloses a containment system for coke drums including a safety shield, a removable cover, a plurality of actuators and a system to vertically position the shield. The Malik patent also discloses an inner shield telescopically disposed within a shield to channel discharge from the coke drum to a switch deck floor.

Despite the current state of the art, there is a need in the art for a system that reliably contains and controls the entire unheading and heading process. There is a further need for such a system that is conducive to remote actuation. There is a still further need for such a system that is modular in construction so as to be easily transported and removably disposed around the bottom closure of a coke drum. There is also an additional need in the art for a system that confines drum discharge when the cover is disengaged from the flange and simplifies the process of delivering the discharge to an unheading deck floor.

### SUMMARY OF THE INVENTION

Accordingly, it is a principal object of the present invention to provide an improved unheading and containment system for a pressure vessel.

According to an aspect of the present invention, an unheading and containment system is provided having an unheading apparatus for removing a cover from a pressure vessel in an unheading operation, and a modular enclosure mechanism. The unheading apparatus includes a cover removably secured to the pressure vessel, a lock plate that cooperates with the cover, and a cover moving mechanism capable of moving the cover vertically and laterally. The modular enclosure mechanism includes a chassis and substantially encloses the cover during the unheading operation. The unheading apparatus may also include a flange mounted to a headed end of the pressure vessel and having a plurality of fasteners cooperating with the lock plate to secure the cover to the pressure vessel when the cover is brought into aligned contact with the flange.

According to another aspect of the present invention, a pressure vessel unheading and containment system is provided having a removable cover closing a pressure vessel bottom outlet and a chassis substantially enclosing an area between the bottom outlet and a support surface, with the cover contained within the enclosed area in an open position and a closed position. The system may also include a flange mounted to the pressure vessel at the bottom outlet and a lock plate cooperatively connected to the cover. The flange and the lock plate cooperate to secure the cover to the bottom outlet.

According to yet another aspect of the present invention, a pressure vessel unheading and containment system is provided having an unheading means for unheading a cover from a bottom outlet of the pressure vessel and an enclosure means for substantially enclosing the unheading operation performed by said unheading means. The system may also include a cover moving means adapted to move the cover vertically and laterally.

The unheading means may comprise a removable cover, a lock plate cooperating with the cover, and a cover moving mechanism capable of moving the cover vertically. The system may also include a flange mounted to the pressure vessel near its bottom outlet and having a plurality of fasteners cooperating with the lock plate to secure the cover to the pressure vessel.

These and other objects, features and advantages of the present invention will be more clearly understood from the following discussion with reference to the following drawings, in which like reference numerals refer to like elements throughout.

### BRIEF DESCRIPTION OF THE DRAWINGS

This invention will be further described with reference to the following drawings, in which:

FIG. 1 shows a vertically-oriented coke drum with a removable cover and a chassis of the present invention provided at a lower end of the drum;

FIG. 2 shows an elevation view of a headed end of the coke drum;

FIG. 3 shows a perspective view of a flange of the present invention attached to a lower end of the drum;

FIG. 4 shows a top plan view of a removable cover of the present invention;

FIG. 5 shows a perspective view of a bottom of the removable cover of the present invention;

FIG. 6 shows a top plan view of a lock plate of the present invention;

FIG. 7 shows a perspective view of the chassis of the present invention;

FIG. 8 is an enlarged elevation view showing a top casing of the present invention mounted to a flange of the present invention;

FIG. 9 shows a top plan view of the unheading and containment system of the present invention;

FIG. 10 shows a side elevation view of the unheading and containment system of the present invention;

FIG. 11 shows an enlarged view of one of the keyhole shaped holes in the lock plate;

FIG. 12 shows an cross-sectional view of a slot in the lock plate;

FIG. 13 shows a cross-sectional view along lines I-I of FIG. 12 with a piston rod of a short-stroke horizontal piston actuator engaged in the slot;

FIG. 14 is an elevation view showing the unheading process of the present invention;

FIG. 15 is an elevation view showing the bolts extended by the bolt tensioners;

FIG. 16 is an elevation view showing the lock plate moved laterally to its unlocked position;

FIG. 17 is an elevation view showing the removable cover lowered from the coke drum onto rails;

FIG. 18 is an elevation view showing the cover moved laterally away from the coke drum to a position under a hood; and

FIG. 19 is an elevation view similar showing the hood raised to permit cleaning of the cover.

### DETAILED DESCRIPTION

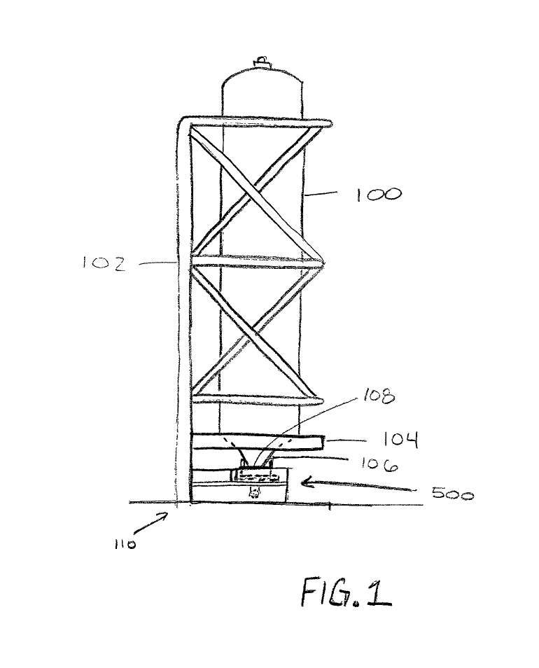

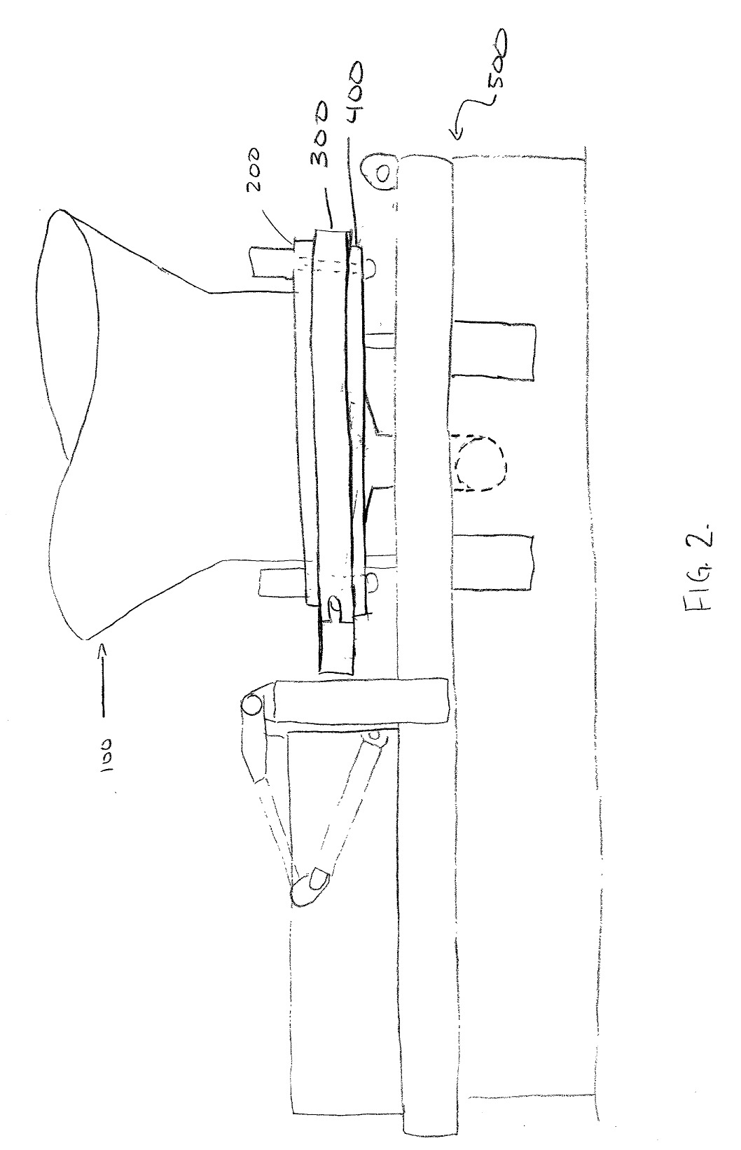

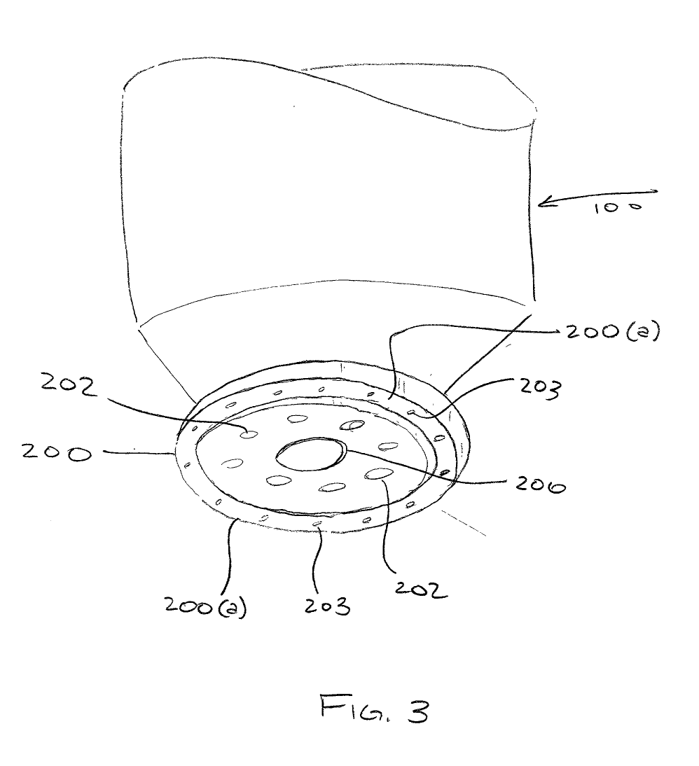

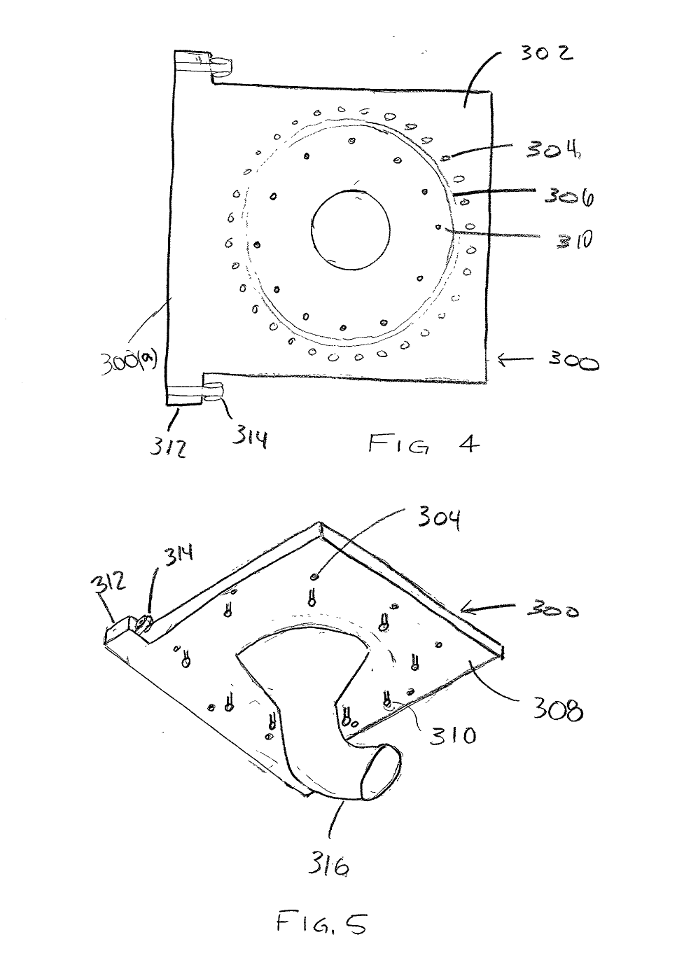

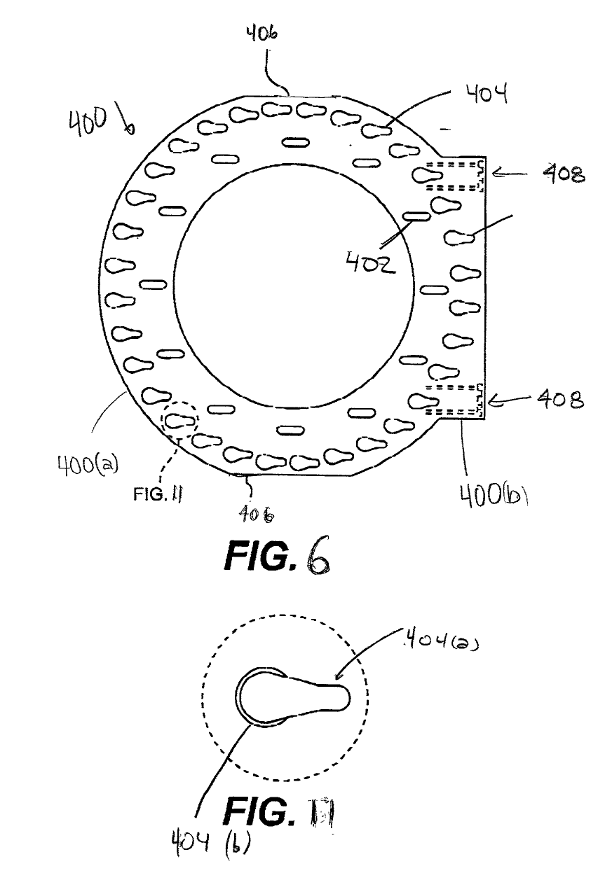

As generally shown in FIG. 1, a coking drum 100 is vertically-oriented and supported by an adjacent support structure 102 that includes a support deck 104 provided near the lower end of the drum. Such a coking drum typically has a conical lower portion 106 narrowing toward an open end 108. Also shown is a chassis 500 which, in a manner described in detail below, encloses the heading and unheading of the drum as well as an area underneath the drum. The chassis is supported through direct connection to the flange 200 by using, for example, a plurality of bolts.

With reference to FIG. 2, the drum 100 is shown headed by three primary components in cooperation with each other: a flange 200; a removable cover 300; and a lock plate 400. The flange itself is secured to the drum by, for example, welding. The cover and the lock plate are removably secured to the flange in a manner discussed in detail below. The flange, the cover, and the lock plate are enclosed within a top casing of the chassis 500 that is removed in this figure.

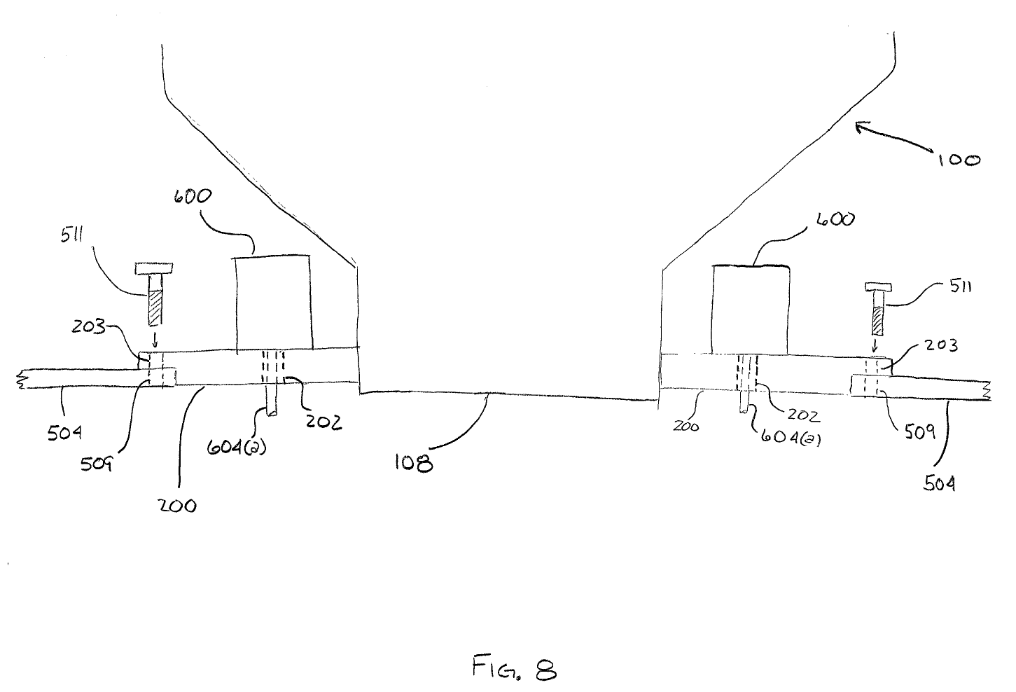

Referring to FIG. 3, the flange 200 is disposed around, and substantially flush with, the open end 108 of the drum 100. The periphery of the flange includes a step portion 200(a). The flange may be constructed of any number of high-strength thermally-stable materials such as low-alloy carbon steel. However, other suitable materials may be substituted, as is well known in the art. Holes 202 are spaced circularly and substantially evenly around the flange. In a manner discussed below, these holes allow bolts (not shown) to extend therethrough. A second set of holes 203 are spaced circularly and evenly around the periphery of the flange in the step portion 200(a). The holes 203 receive bolts (unshown) for securing a top casing 504 (shown in FIG. 7) of the chassis. In addition, an opening 204 is located in the center of the flange. The opening allows coke and quench water to exit through the open end of the drum during a decoking process. The opening is generally circular, which is an advantageous configuration for a drum of circular cross-section. However, the opening can take other shapes. In the illustrated embodiment, a minute portion of the drum extends beyond the flange forming a lip 206 to encourage a tight seal between the open end of the drum 108 and the removable cover 300, in a manner discussed in detail below.

Turning to FIGS. 4 and 5, the removable cover 300 is shown to be generally rectangular in configuration. The removable cover has an elongated end 300(a) extending from the left side of the cover as it is illustrated in FIGS. 4 and 5 and an upper surface 302 adapted to mate and tightly seal with the flange 200. To this end, a groove 306 is provided on the upper surface of the removable cover and is configured to accept a gasket. In the illustrated embodiment, the groove is circular. However, it is to be understood that the configuration of the groove may be varied. The removable cover also includes through holes 304, shoulder bolts 310, and a pair of wing-like projections 312. In the illustrated embodiment, the through holes are spaced circularly and substantially evenly around the periphery of the groove 306, but their location and configuration may be varied as will be discussed in detail below.

The wing-like projections 312 are located at the elongated end 300(a) of the removable cover. In the illustrated embodiment, the projections are integrally formed with the cover and share the same material thickness. Pivotable connectors 314 extend backwardly from the projections. Each pivotable connector is located and configured to engage the distal end of a piston rod (not shown in this figure) and thus allow the removable cover to remain engaged to the actuator associated with the rod at all times.

The shoulder bolts 310, best seen in FIG. 5, extend from the underside 308 of the removable cover 300. In a manner discussed in detail below, the shoulder bolts allow for slidable mounting of the lock plate 400. The number and configuration of the shoulder bolts, it is to be understood, may vary, depending on, inter alia, various design choices of the removable cover, the lock plate, and the shoulder bolts themselves. The removable cover also includes a lateral conduit 316 attached to its underside. The conduit 316 is used for feeding hydrocarbon, steam and water into the drum through the open end 108, as well as to drain water and other byproducts from the drum during deheading.

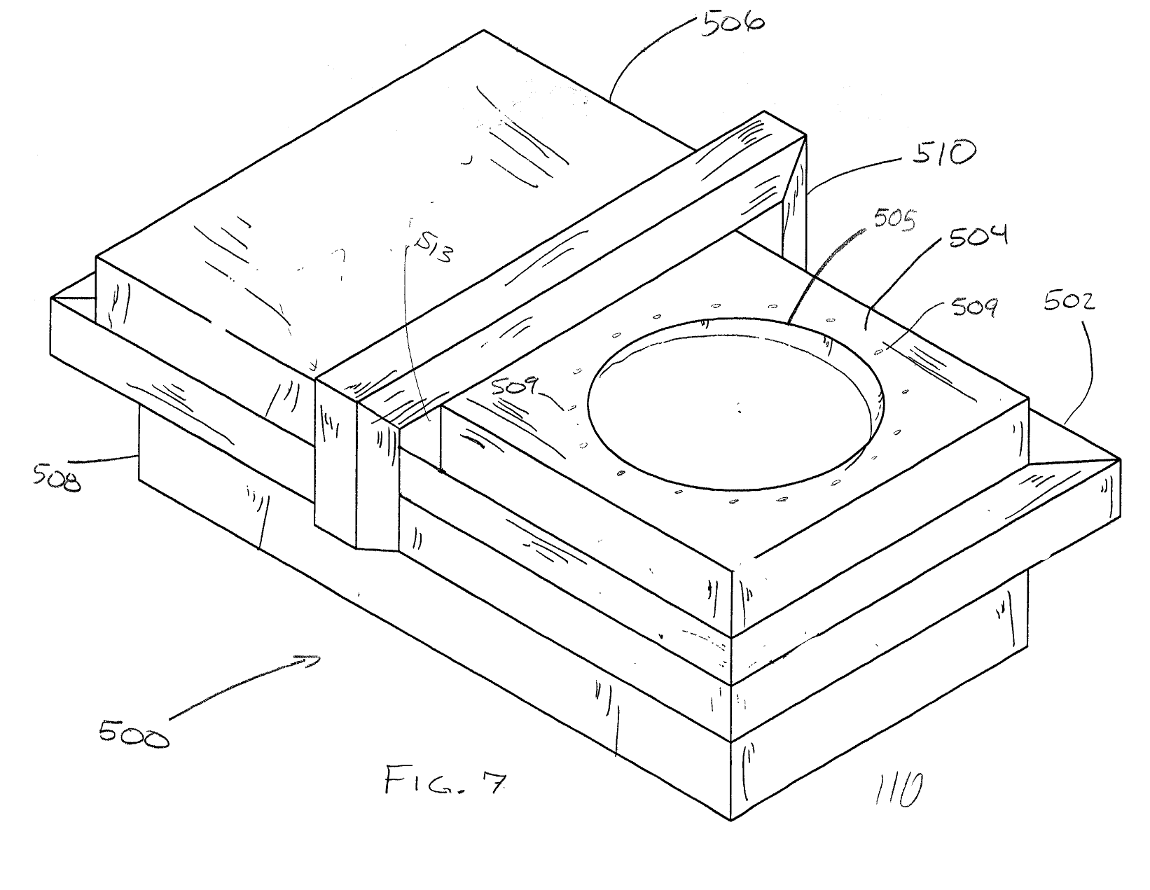

FIG. 6 illustrates the lock plate 400 of the present invention. The lock plate is a truncated annulus having an annular portion 400(a), a squared end 400(b) and straight sections 406. This annular shape is an advantageous configuration for a drum of circular cross-section. However, the lock plate can take other shapes. The lock plate is dimensioned to travel within the chassis 500 in a manner discussed in detail below. The straight sections 406 allow for an annular portion of greater diameter while allowing for enclosed travel of the lock plate within the chassis 500.

Slotted holes 402 and holes 404 are spaced circularly and substantially evenly around the lock plate 400. The slotted holes are dimensioned to accept, and cooperate with, the shoulder bolts 310 extending from the removable cover. Thus, the number and location of the slotted holes corresponds to the number and location of the shoulder bolts. The holes 404 are located so as to align with the holes 304 of the removable cover 300 and the holes 202 of the flange 200 when the drum is headed by the removable cover.

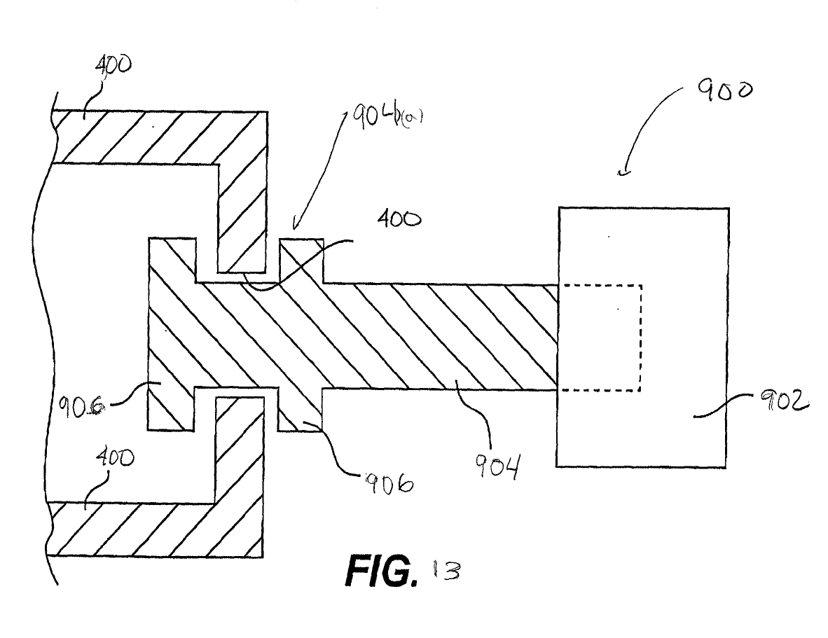

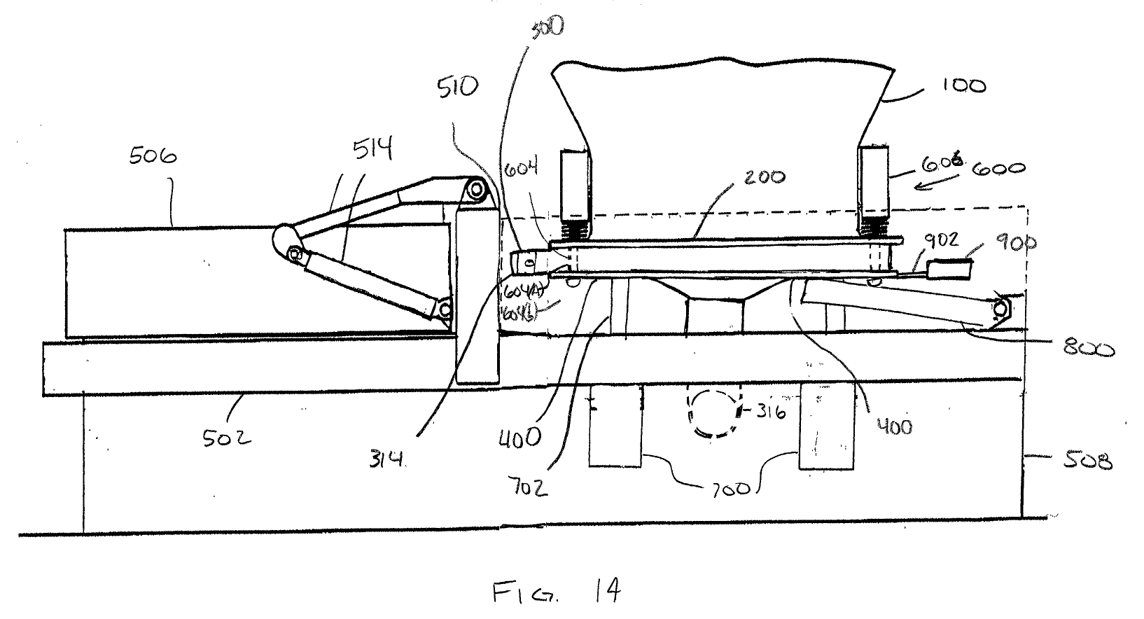

The lock plate also includes slots 408 on its squared end 400(b). Each slot, in a manner discussed in detail below in conjunction with FIG. 12, is located and configured to engage and removably retain the complimentary configured distal end of a piston rod (shown in FIG. 13).

The lock plate 400 is slidably mounted to the underside of the removable cover 300 by the shoulder bolts 310. The shoulder bolts extend through, and cooperate with, the slotted holes 402 so as to allow limited slidable movement of the lock plate relative to the removable cover.

FIG. 7 shows the chassis 500 that encloses the open end 108 of the drum 100, the flange 200, the removable cover 300, and the lock plate 400. The chassis, in a manner discussed in detail below, bears the full load of the removable cover and lock plate as well as a portion of the load imposed on the removable cover by the contents of drum 100 while the drum is headed. The chassis includes a chassis body 502, a top casing 504, a hood 506, a skirt 508 and a box beam 510.

The chassis 500 is generally rectangular in both cross-section and configuration and provides the primary structural support. The chassis is dimensioned to enclose an area wider than the removable cover 300 and extends through an opening in the floor 110. The top casing 504 is disposed on an upper side of the chassis and includes a drum opening 505 for receiving the lower end of the drum. Holes 509 are spaced around the opening and aligned with the holes 203 in the flange 200. Bolts 511 extend through the holes 509 and 203 to secure the chassis to the flange.

The hood 506 is hinged to the chassis 500 by a hinge 507 (shown in FIG. 9) and is tiltable about the hinge by an actuator assembly 514 (also shown in FIG. 9). When the hood is in its rest position, as shown in FIG. 7, it seats against the chassis body 502 and the box beam 510. The hood is provided with a gasket (not shown) to ensure that the hood-chassis and hood-box beam joints are sealed to prevent drum discharge from escaping during the unheading and decoking procedures. This gasket is seated around the periphery of the open end of the hood. A second gasket, circular in shape, is provided between the cover 300 and the flange 200 and normally rests in the groove 306 of the cover. After the unheading and decoking procedures are complete the hood may be titled upwardly about the hinge to permit cleaning of the removable cover 300. While the hood is raised, the second gasket, which would preferably be a double metal jacketed gasket, can be replaced. The hood is wider than the top casing to provide openings 513 for receiving piston rods in a manner discussed in detail below.

The skirt 508 is attached to a lower side of the chassis body 502. The skirt is preferably formed of a relatively high-strength material such as a low alloy carbon steel. Other suitable materials, well known in the art, can be substituted. The skirt 508 extends downwardly from the chassis through the floor 110. Thus, the skirt 508, the box beam 510, the hood 506, the top casing 504, and the chassis body 502 cooperate to substantially enclose the area from the floor to past the open end of the drum to confine any discharge from the drum during an unheading and decoking procedure.

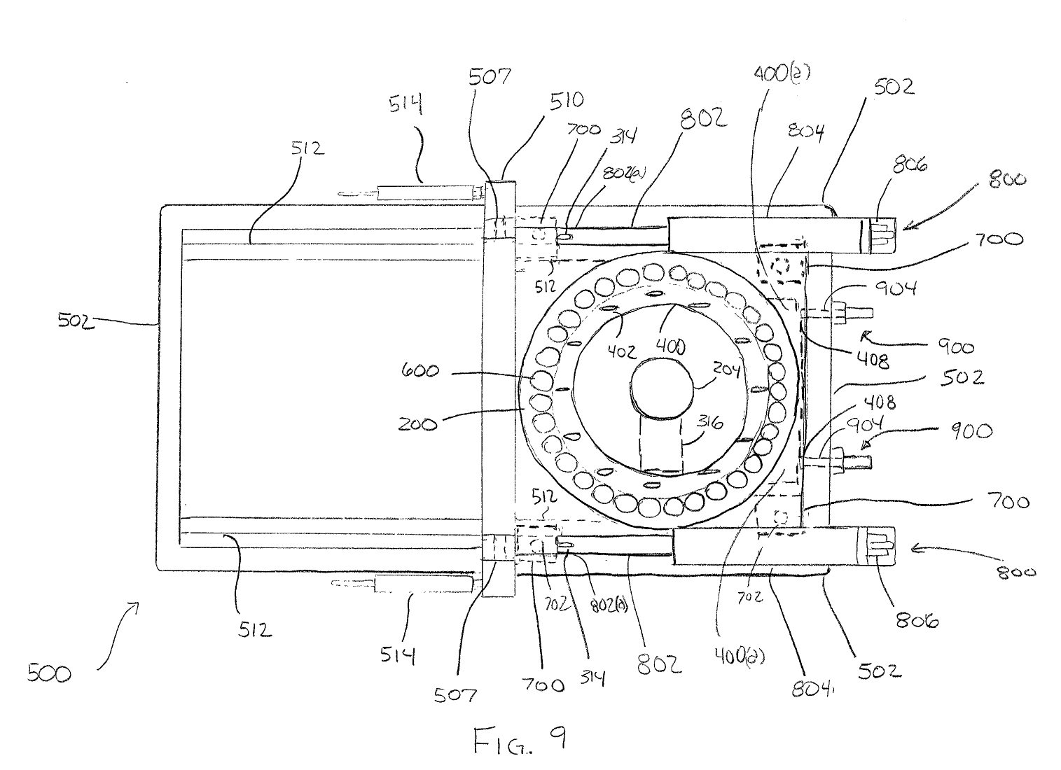

As illustrated in FIG. 8, the step portion 200(a) of the flange 200 is dimensioned to accept the portion of the top casing 504 between the holes 509 and the drum opening 505. The holes 203 of the step portion are aligned with the holes 509 of the top casing 504. The holes 203 and 509 are aligned and dimensioned to accept the bolts 511 to secure the chassis to the flange. When secured to the flange, a portion of the upper surface of the top casing seats in the step portion 200(a) of the flange. In this manner, the flange supports the weight of the chassis 500.

FIG. 9 shows a plan view of the present invention with the drum 100, the hood 506, and the top casing 504 removed. Rails 512 extends laterally within the chassis 500 along its length and are configured to allow removable cover 300 to travel thereon. The rails can be single element or, alternatively, a series of aligned shorter rails. Also shown is the actuator assembly 514 for tilting the hood. The actuator assembly is connected at one end to the box beam 510 and at the other to the hood.

Several sets of actuators mounted to the chassis 500 are used to move the removable cover 300 and the lock plate 400 within the chassis from a headed position wherein the removable cover is mated to the flange 200, to an unheaded position wherein the removable cover is in a position adjacent to the drum. The term “actuator” includes any mechanical, electrical or hydraulic device to position the removable cover or the lock plate.

As best seen in FIG. 9, the chassis 500 includes four vertically-oriented piston actuators 700 for providing a lifting force on the cover to lower and raise the removable cover 300 during unheading and heading. The vertically-oriented piston actuators are mounted to the underside of the chassis body 502 above the skirt. The vertically-oriented piston actuators are capable of providing sufficient lifting force to maintain the removable cover in the mated position during the unheading and heading process.

Each vertically-oriented piston actuator 700 includes a piston rod 702 configured to engage the underside 308 of the removable cover. In the illustrated embodiment, the vertically-oriented piston actuators are arranged to engage the corners of the removable cover when the removable cover is in alignment with the drum. The removable cover is lowered onto the rails 512 of the chassis by the piston actuators, preferably at a level plane such that the upper surface 302 of the removable cover is parallel to the flange 200 throughout the unheading and heading cycle. As will be appreciated, the location and configuration of the vertically-oriented piston actuators can vary and still be able to raise and lower the cover.

Still referring to FIG. 9, the chassis 500 also includes dual horizontally-oriented long-stroke piston actuators 800 adapted for controllably moving the removable cover 300 laterally within the chassis 500 on the rails 512. Each horizontally-oriented long-stroke piston actuator includes a piston rod 802 slidably disposed in a cylinder 804. Further, the distal ends 802(a) of the rods 802 is configured to pivotably engage the pivotal connectors 314 of the removable cover. The engagement may be achieved through any number of means typical in the art, including, for example, a hinge arrangement. This pivotable engagement allows the horizontally-oriented long-stroke piston actuators 800 to remain engaged to the removable cover throughout the heading and unheading cycle. To maintain an operative connection with the chassis, the horizontally-oriented long-stroke piston actuators are attached to the chassis by hinges 806.

After removable cover 300 is lowered onto rails 512 by the vertically-oriented piston actuators 700, in a manner discussed in detail below, the horizontally-oriented piston actuators 800 are actuated to extend the rods 802 and move the cover from an aligned position under the drum 100 to an offset position relative to the drum. When extended, the rods 802 travel through the openings 509 in the chassis 500. The openings receive the rods 802 but can otherwise be sealed to prevent discharge from the drum 100 from escaping during the unheading and decoking operations.

Multiple bolt tensioning units 600 are mounted on the top side of the flange 200. The tensioning units may be mounted to the flange by any conventional means, such as, for example, mounting brackets and bolts or the like. In the illustrated embodiment, the tensioning units are circularly and substantially evenly spaced around the periphery of the flange. However, the number and location of the tensioning units may vary, depending on, inter alia, the construction of the flange and the pressure rating of the drum. The locations of the tensioning units correspond to the locations of the holes 202 of the flange.

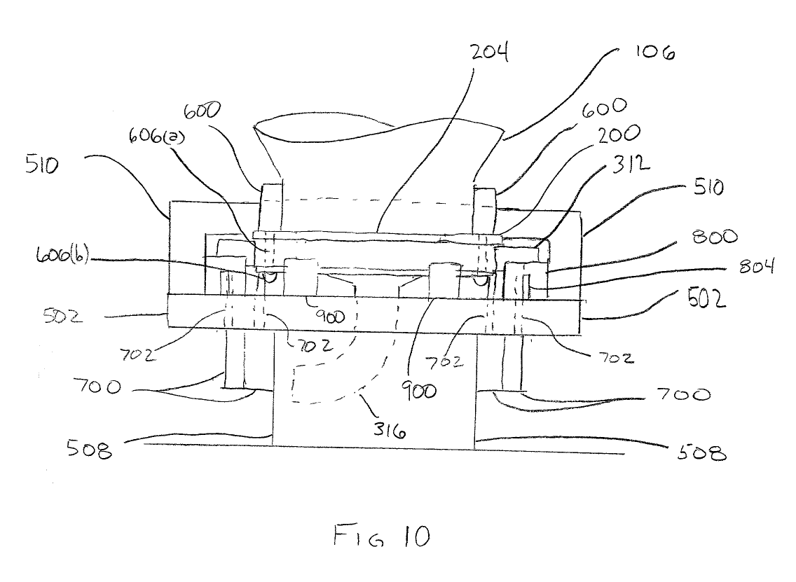

Each tensioning unit 600 is constructed and operated similarly. As best seen in FIG. 10, each bolt tensioning unit 600 comprises a cylinder 604 and a bolt 606. The tensioning units are usually operated by a suitable hydraulic pressure source. U.S. Pat. Nos. 6,223,925 and 6,085,929 to Malsbury et al., which are incorporated herein by reference, disclose a bolt tensioning unit that can be utilized for the purposes described herein.

Still referring to FIG. 10, each bolt is slidably disposed in the cylinder of the tensioning unit. Each bolt 606 includes a shank 606(a) and a head 606(b) at its distal end. The head, which can be either secured to the bolt or integrally formed therewith, is larger in diameter than the shank portion in cross section, but small enough to fit through the holes 202 of the flange 200, the holes 304 in the removable cover 300 and, as is discussed in detail below, a portion of the holes 404 in the lock plate 400. Preferably, the bolt head is a hex nut or the like, which is threaded onto the bolt. This provides a convenient means for making fine adjustments to the location of the head relative to the other elements of the mechanism.

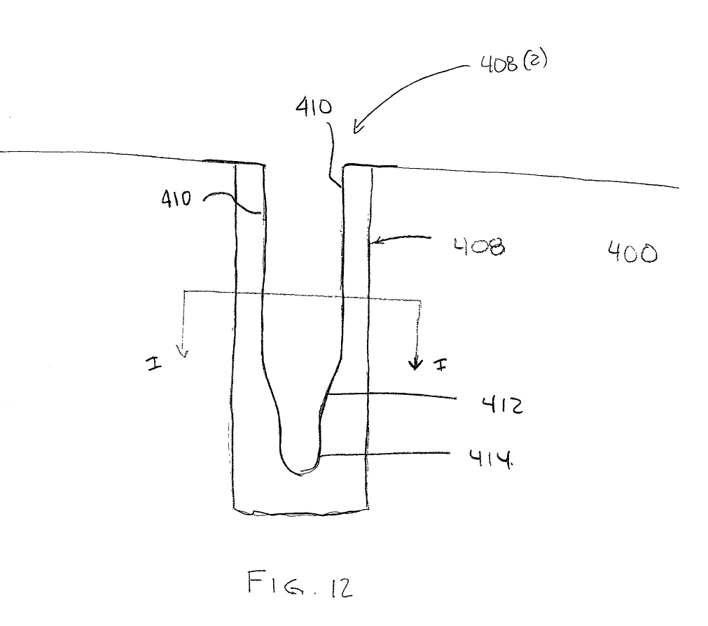

As best seen in FIG. 11, each hole 404 includes at least two different-sized regions that are alternately alignable with the bolts; a narrowed portion 404(a), through which the heads 606(b) of the bolts 606 cannot fit longitudinally; and an enlarged portion 404(b), through which the heads of the bolts can fit longitudinally. The holes can be shaped in any of several ways to achieve this result. In the illustrated embodiment, the hole is key-hole shaped. However, one of ordinary skill in the art will recognize that other configurations are possible. The portion of the lock plate surrounding the narrowed portion of the holes therefore provide bearing surfaces for the bolt heads.

As discussed above, the lock plate 400 is slidably mounted to the underside 308 of the removable cover 300 by the shoulder bolts 310. The shoulder bolts extend through the slots 402, which slots are configured to allow limited selective lateral movement of the lock plate 400 relative to the removable cover. Thus, the lock plate can be moved from a “locked” position in which the narrowed portions 404(a) of the holes 404 are aligned with the bolt heads 112(b) to an “unlocked” position in which the enlarged portions of the holes are aligned with the bolt heads.

As shown in FIG. 10, when the drum is headed, the removable cover 300 is sandwiched between the flange 200 and the lock plate 400. In this condition, the lock plate is in the locked position and the bolts 606 extend through the holes 202 in the flange, the holes 304 in the removable cover, and the narrowed portions 404(a) of the holes 404 of the lock plate.

The slots 408 of the lock plate 400, shown in cross-section in FIGS. 12 and 13, are configured to automatically engage the complimentary configured distal ends of the piston rods 904 of the horizontally-oriented short-stroke piston actuators 900 when the removable cover 300 is raised in a manner discussed in detail below. In this illustrated embodiment, each slot includes parallel sidewalls 410 extending from a slot opening 408(a) and a narrowing portion 412 wherein the sidewalls taper inwardly toward a capture portion 414 at the distal end of the slot.

The horizontally-oriented short-stroke piston actuators 900 are positioned on the chassis 500 to move the lock plate 400 from its locked position to its unlocked position. Each horizontally-oriented short-stroke piston actuator comprises a cylinder 902 and a rod 904. As FIG. 13 illustrates, the distal ends 904(a) of the rods are provided with extensions 906 to engage slots 408 of the lock plate. In the illustrated embodiment, the distal end is greater in diameter than the remainder of the rod and extensions 906 are formed by a circumferential groove in the distal end. However, one of ordinary skill in the art will recognize that other configurations are possible, such as laterally extending wings. The horizontally-oriented short-stroke piston actuators 900, when actuated, selectively retract or extend the rods, thus moving the lock plate.

As the removable cover 300 is raised by the vertically-oriented piston actuators 700, the distal ends 904(a) of the rods 904 slide down the slots 408. As the removable cover continues to rise, the rod slides to a final position seated in the capture portion 414. Thus, the extensions 906, in cooperation with the slots 408, allow the rods 904 to engage with, and disengage from, the lock plate 400 when removable cover 300 is in the aligned position and raised or lowered by the vertically-oriented piston actuators.

The lock plate 400 is moved by the horizontally-oriented piston actuators, preferably by at least two bi-directional piston actuators.

In a particularly advantageous application, the present invention may be used with what is commonly referred to as an “unheading deck floor.” An unheading deck floor typically has an opening that leads to a coke pit below. In a conventional unheading deck floor installation two chutes are required; a “first chute” extending from the drum opening to the floor opening, and a “second chute” extending from the floor opening to the coke pit.

When employed with an unheading deck floor, the chassis and the skirt, which enclose the area from past the open end 108 of the drum 100 through the floor 110, may be used to channel water and coke exiting the open end of the drum in place of the “first chute.” Consequently, the need for any additional structures such as a coke chute extending from the drum to the floor is obviated.

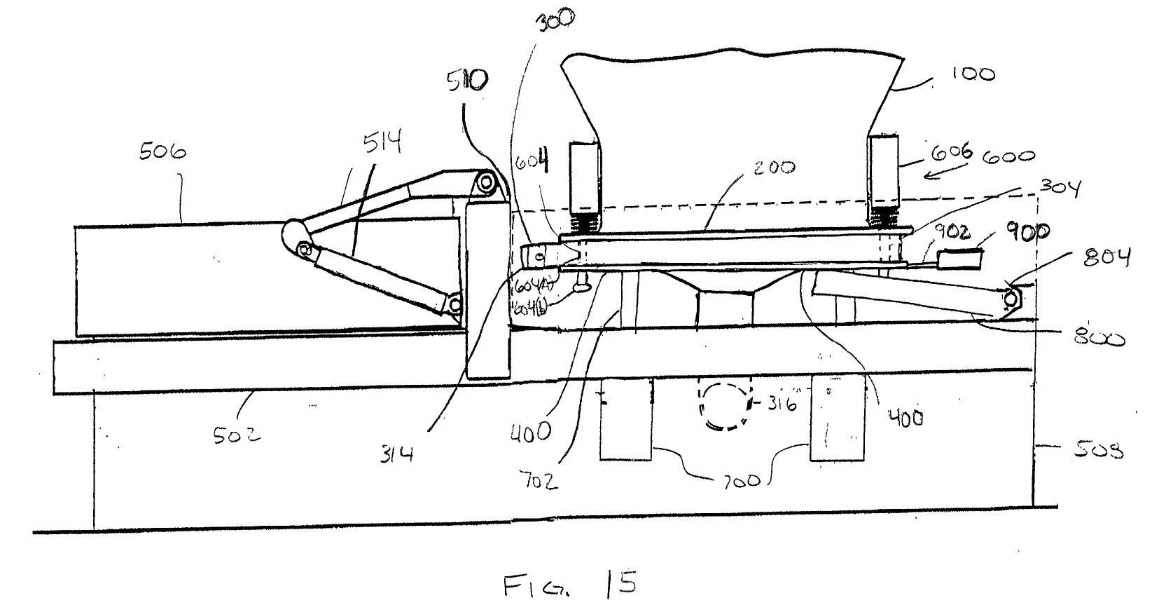

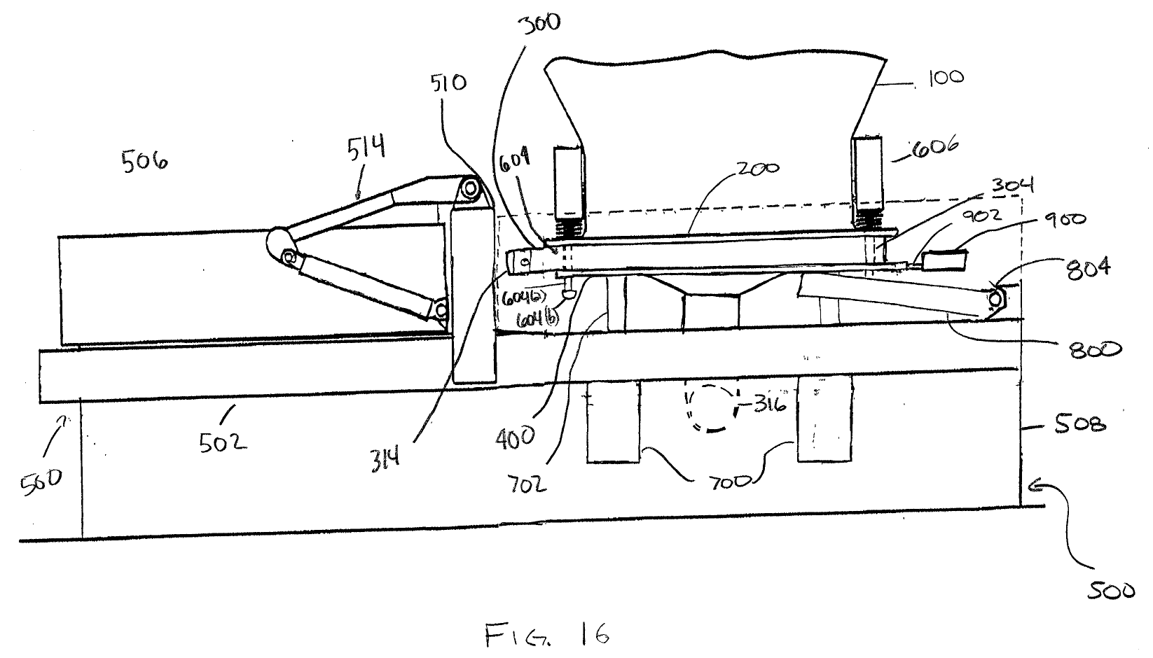

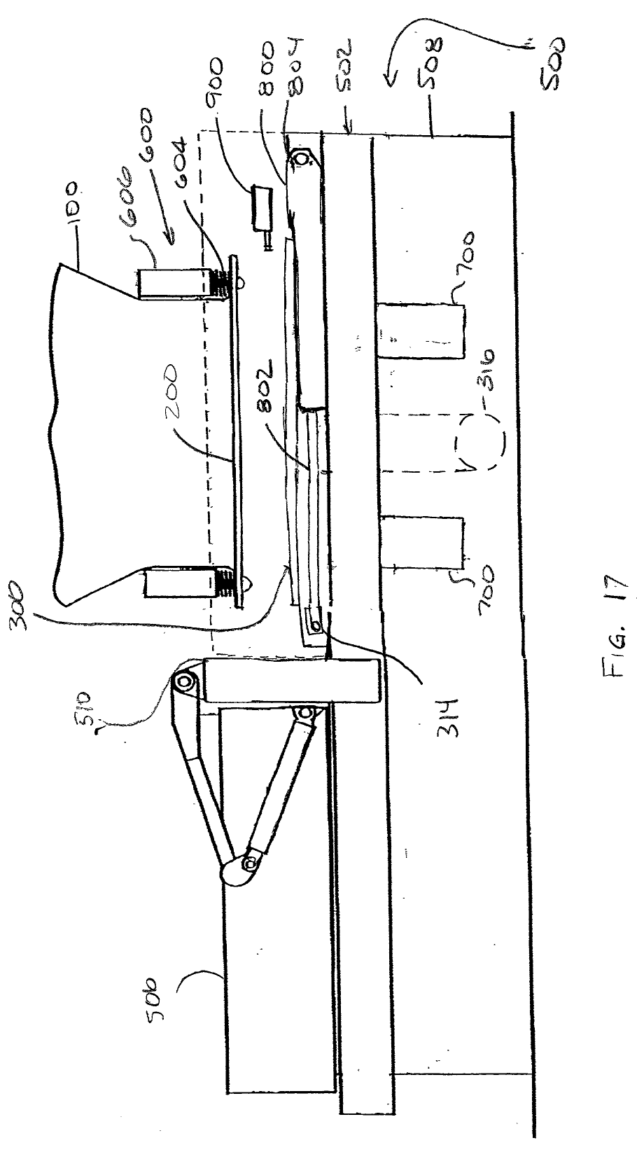

Referring now to FIGS. 14-19, which show the present invention with the top casing 504 removed for clarity, an unheading operation is described. As shown in FIG. 14, with the rod 802 removed for clarity, the drum 100 is headed by the removable cover 300. In this condition, the vertically-oriented piston actuators 700 apply a lifting force to the removable cover 300 and the lock plate 400 via the rods 702. In turn, the rods transfer the full load of the removable cover, as well as a portion of the load bearing on the removable cover by the drum's contents to the chassis 500. Next, as shown in FIGS. 15 and 16, the tensioning units 600 are actuated to extend the bolts 606. In this condition the flange-cover joint is detensioned allowing slidable movement of the lock plate 400.

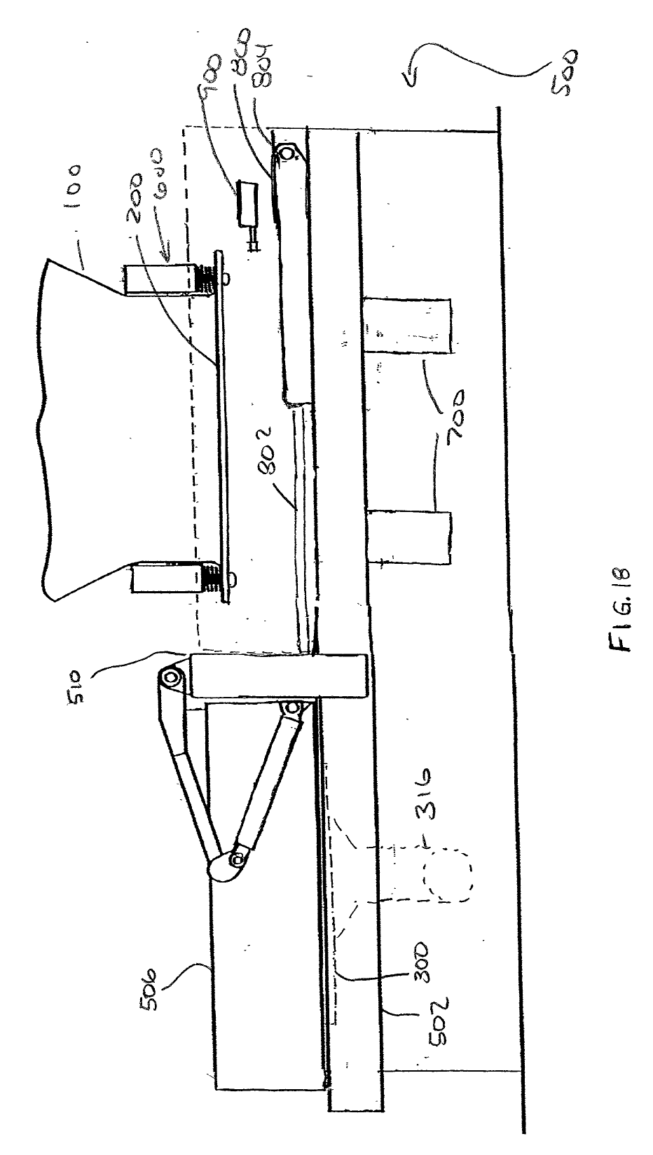

Then, as FIG. 16 illustrates, the horizontally-oriented short-stroke piston actuators 900 are actuated to retract the rods 904 and horizontally move the lock plate 400 engaged thereto from a locked position to an unlocked position. In the unlocked position, the enlarged portions 404(b) of the holes 404 are aligned with the bolts 606, thereby allowing the lock plate 400, and thus the removable cover 300, to be separated from the flange 200. Thereafter, the vertically-oriented piston actuators decrease the amount of lifting force applied to the removable cover allowing the weight of the removable cover 300, the lock plate 400, and the contents of drum 100 to gradually and controllably overcome the lifting force. This net downward force retracts the rods 702, thus controllably lowering the removable cover onto the rails 512 of the chassis 500, as shown by FIG. 17.

It is to be appreciated that several mechanical actions take place during the lowering of the removable cover 300. First, as the removable cover is lowered, the distal ends 904(a) of the rods 904 slide up and out of the slots 408 of the lock plate 400. Second, the horizontally-oriented long-stroke piston actuators 800, pivoted upward by virtue of the position of the projections 312 and the pivotable connectors 314, pivot to a substantially horizontal position about the hinge 804. In this position the horizontally-oriented long-stroke piston actuators 800 are parallel to the rails 512.

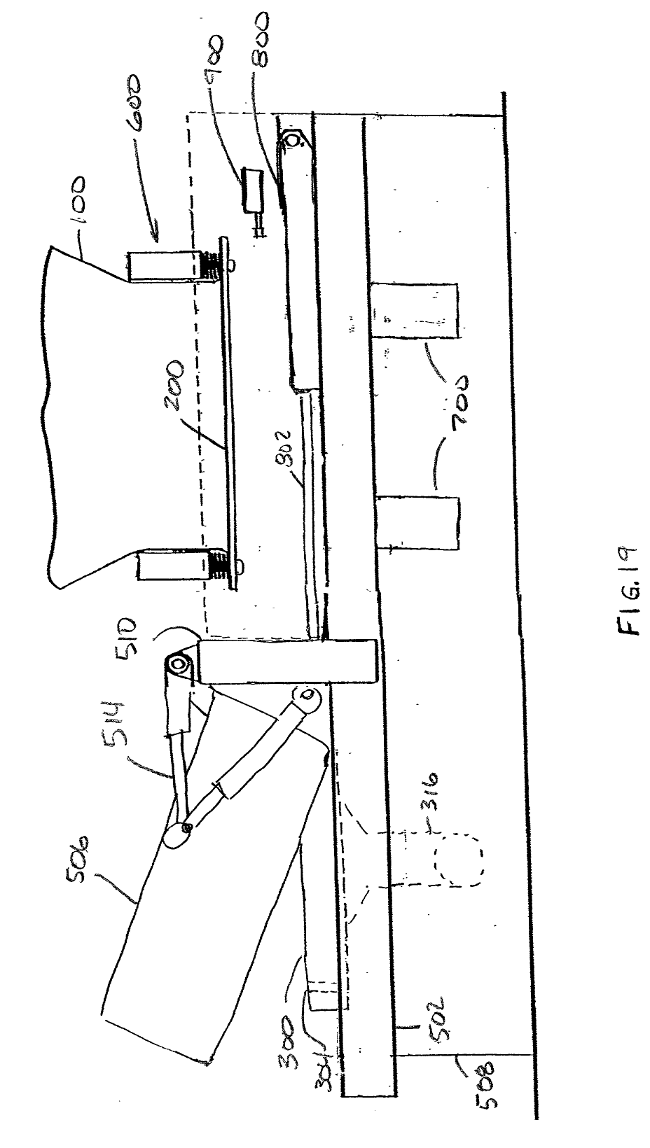

As best seen in FIG. 18, when the removable cover has been lowered onto the rails 512 and the vertically-oriented piston actuators 700 retracted, the horizontally-oriented long-stroke piston actuators 800 are actuated thus extending the rods 802 and moving the removable cover 300 laterally aside to a position adjacent to the drum 100. As illustrated, the cover is completely under the hood 506. The rods 802 extend through the openings 513 while the removable cover travels on the rails 512.

Lastly, as FIG. 19 illustrates, if desired, and after all of the drums contents, including the coke, have been removed, the hood 506 may be tilted by the actuator assembly 514 about the hinge 507 to gain access to the cover for cleaning. In this position, it is also possible (and usually desirable) to replace the gasket between the cover and the flange.

It should be appreciated that throughout the unheading operation the removable cover 300 remains within the chassis 500. In addition, it is to be understood that to head the drum 100, the aforesaid operations are to be performed in reverse order.

While the present invention has been described with respect to what is at present considered to be the preferred embodiment, it should be understood that the invention is not limited to the disclosed embodiment. To the contrary, as exemplified above, the invention is intended to cover various modifications and equivalent arrangements included within the spirit and scope of the appended claims. For example, rather than employing hydraulic pressure to actuate the pistons and/or move the lock plate, various mechanical drive mechanisms can be used instead, as will be appreciated by those skilled in the art. Additionally, the inventive closure mechanism can be employed in other environments, such as autoclaves or other pressure vessels. Therefore, the scope of the following claims is intended to be accorded the broadest reasonable interpretations so as to encompass all such modifications and equivalent structures and functions.

We claim:

1. A pressure vessel unheading and containment system, comprising:
an unheading apparatus for removing a cover from a pressure vessel in an unheading operation, said apparatus including a cover removably secured to the pressure vessel and a lock plate cooperating with said cover, and a cover moving mechanism capable of moving said cover vertically and laterally; and
a modular enclosure mechanism including a chassis and substantially enclosing said cover during the unheading operation.

2. The system according to claim 1, wherein the unheading apparatus further comprises a flange mounted to a headed end of the pressure vessel, said flange having a plurality of fasteners cooperating with said lock plate to secure said cover to the pressure vessel when said cover is brought into aligned contact with said flange.

3. The system according to claim 2, wherein said fasteners include a plurality of actuators for extending and retracting bolts therefrom.

4. The system according to claim 3, wherein said bolts include a head at one end and each being slidably attached to an actuator at the other end, and
wherein said lock plate includes a plurality of holes, the holes having (i) a wider portion through which said bolt head can pass and (ii) a narrower portion through which the bolt head cannot pass, said lock plate being movable between a first position, in which the narrower portions of the holes are aligned with said bolts, and a second position, in which the wider portions of the holes are aligned with said bolts.

5. The system according to claim 4, further comprising a lock plate moving mechanism capable of moving said lock plate laterally.

6. The system according to claim 5, wherein said lock plate moving mechanism comprises at least one horizontally-oriented actuator adapted to move said lock plate laterally between the first and second positions.

7. The system according to claim 6, wherein said horizontally-oriented actuator includes a rod, and said lock plate includes slots adapted to removably engage said rod when said cover is lifted into contact with the pressure vessel.

8. The system according to claim 4, wherein said cover has througholes dimensioned and located to allow said bolts to extend therethrough when said cover is brought into aligned contact with said flange.

9. The system according to claim 1, wherein said cover moving mechanism includes at least one vertically-oriented actuator to move said cover vertically.

10. The system according to claim 1, wherein said cover moving mechanism includes at least one horizontally-oriented actuator to move said cover laterally and guide rails disposed within said enclosure mechanism to slidably support said cover.

11. The system according to claim 10, wherein said cover includes at least one projection adapted to engage said horizontally-oriented actuator.

12. The system according to claim 1, wherein said chassis includes a tiltable hood, said hood being tiltable relative to said chassis from a closed position to an open position.

13. The system according to claim 1, wherein said chassis includes a skirt adapted to extend through an unheading deck to confine discharges from the pressure vessel.

14. A pressure vessel unheading and containment system, comprising
a removable cover closing a pressure vessel bottom outlet; and
a chassis substantially enclosing an area between the bottom outlet and through an unheading deck, with said cover contained within the enclosed area in an open position and a closed position.

15. A system according to claim 14, further comprising:
a flange mounted to the pressure vessel at the bottom outlet; and
a lock plate cooperatively connected to said cover, with said flange and said lock plate cooperating to secure said cover to the bottom outlet.

16. The system according to claim 15, further comprising a plurality of fasteners mounted on said flange and cooperating with said lock plate to secure said cover to the pressure vessel when the cover is brought into aligned contact with said flange.

17. The system according to claim 16, wherein said fasteners include a plurality of actuators for extending and retracting bolts therefrom.

18. The system according to claim 17, wherein said bolts include a head at one end and each being slidably attached to an actuator at another other end, and wherein
said lock plate has a plurality of holes, the holes having (i) a wider portion through which said bolt head can pass and (ii) a narrower portion through which said bolt head cannot pass, said lock plate being movable between a first position, in which the narrower portions of the holes are aligned with said bolts, and a second position, in which the wider portions of the holes are aligned with said bolts.

19. The system according to claim 18, further comprising a lock plate moving mechanism capable of moving said lock plate laterally between the first and second positions.

20. The system according to claim 19, wherein said lock plate moving mechanism comprises at least one horizontally-oriented actuator to move said lock plate laterally.

21. The system according to claim 20, wherein said actuator includes a rod, and said lock plate includes slots adapted to removably engage said rod when said cover is lifted into contact with the pressure vessel.

22. The system according to claim 18, wherein said cover has througholes dimensioned and located to allow said bolts to extend therethrough when said cover is brought into aligned contact with said flange.

23. The system according to claim 1, further comprising a cover moving mechanism capable of moving said cover vertically and laterally.

24. The system according to claim 23, wherein said cover moving mechanism includes at least one vertically-oriented actuator to move said cover vertically.

25. The system according to claim 23, wherein said cover moving mechanism includes at least one horizontally-oriented actuator to move said cover laterally and guide rails disposed within said chassis to slidably support said cover.

26. The system according to claim 25, wherein said cover includes at least one projection adapted to engage said horizontally-oriented actuator.

27. The system according to claim 14, wherein said chassis includes a hood, tiltable relative to said chassis from a closed position to an open position.

28. The system according to claim 14, wherein said chassis includes a skirt adapted to extend through an unheading deck to confine discharges from the pressure vessel during the deheading operation.

29. A pressure vessel unheading and containment system, comprising:
unheading means for unheading a cover from a bottom outlet of the pressure vessel; and
enclosure means for substantially enclosing the unheading operation performed by said unheading means.

30. The system according to claim 29, further comprising cover moving means adapted to move the cover vertically.

31. The system according to claim 30, wherein said cover moving means comprises at least one vertically-oriented actuator and at least one horizontally oriented actuator.

32. The system according to claim 29, wherein said unheading means comprises a removable cover, a lock plate cooperating with said cover, and a cover moving mechanism capable of moving said cover vertically and laterally.

33. The system according to claim 32, further comprising a flange mounted to the pressure vessel at its bottom outlet, said flange having a plurality of fasteners cooperating with said lock plate to secure the cover to the pressure vessel.

34. The system according to claim 29, wherein said unheading means includes a lock plate moving mechanism capable of moving said lock plate laterally.

35. The system according to claim 29, wherein said enclosure means comprises a chassis, said chassis adapted to be supported by a flange on the pressure vessel and substantially enclosing an area to confine the cover during the unheading operation.

36. The system according to claim 2, further comprising means for supporting said chassis from said flange.
